(19) United States
(12) Patent Application Publication
(10) Pub. No.: US 2025/0103262 A1
(43) Pub. Date: Mar. 27, 2025

(54) IMAGE PROCESSING SYSTEM, NON-TRANSITORY COMPUTER READABLE MEDIUM STORING PROGRAM, AND IMAGE PROCESSING METHOD

(71) Applicant: FUJIFILM Business Innovation Corp., Tokyo (JP)

(72) Inventor: Toshiharu HAYASHIDA, Kanagawa (JP)

(73) Assignee: FUJIFILM Business Innovation Corp., Tokyo (JP)

(21) Appl. No.: 18/596,545

(22) Filed: Mar. 5, 2024

(30) Foreign Application Priority Data
Sep. 21, 2023 (JP) 2023-154062

(51) Int. Cl. G06F 3/14; G06T 3/40; G06V 30/10; H04N 1/00

(52) U.S. Cl. CPC G06F 3/14; G06T 3/40; G06V 30/10; H04N 1/0044

(57) ABSTRACT

An image processing system includes an imaging unit, and a processor, in which the processor is configured to display a captured image of an original document captured by the imaging unit in a case where a reading attribute set by a user in a case where a read image of the original document is generated, and an attribute value of the reading attribute are designated, acquire a position on the captured image designated by the user, generate a preview image of the original document in accordance with the designated attribute value by using a partial region on the original document including the acquired position as a generation range, and display the preview image in an enlarged manner.

### CROSS-REFERENCE TO RELATED APPLICATIONS

This application is based on and claims priority under 35 USC 119 from Japanese Patent Application No. 2023-154062 filed Sep. 21, 2023.

### BACKGROUND

### (i) Technical Field

The present invention relates to an image processing system, a non-transitory computer readable medium storing a program, and an image processing method.

### (ii) Related Art

In a case where an original document is scanned to generate a read image, various reading attributes such as a color mode and a resolution can be generally set. Therefore, there is a case where a user wants to check whether or not the appropriateness/inappropriateness of a setting of an attribute value of the reading attribute before the user generates and saves the read image of the original document. In this case, the user can check in advance what kind of read image is created by major scanning by generating a preview image before the read image of the original document is officially generated by the major scanning.

For example, in JP2008-252537A, a plurality of patterns of scan setting data are generated by combining selection candidates for a setting value in each setting item such as a resolution, a color, or a data format, a preview image corresponding to each scan setting data is generated by pre-scanning an original document, and the preview image is provided to a user. The user can check the appropriateness/inappropriateness of the combination of the setting values in each setting item by viewing the preview image corresponding to each scan setting data.

### SUMMARY

However, in the related art, in a case where there are many selection candidates for the attribute value in each reading attribute of the original document, the number of preview images provided is increased. In this case, the user has to search for the preview image generated by a combination of intended attribute values from a large number of preview images. Therefore, it is difficult to efficiently search for the attribute value of the reading attribute set in the generation of the read image of the original document.

Aspects of non-limiting embodiments of the present disclosure relate to an image processing system, a non-transitory computer readable medium storing a program, and an image processing method that, in a case where a user checks appropriateness/inappropriateness of a setting of an attribute value of a reading attribute by a preview image before a read image of an original document is generated, can more easily check the appropriateness/inappropriateness of the attribute value than in a case where a plurality of preview images are generated by combining the attribute values of the reading attribute used by the user as selection candidates.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image processing system including an imaging unit, and a processor, in which the processor is configured to display a captured image of an original document captured by the imaging unit in a case where a reading attribute set by a user in a case where a read image of the original document is generated, and an attribute value of the reading attribute are designated, acquire a position on the captured image designated by the user, generate a preview image of the original document in accordance with the designated attribute value by using a partial region on the original document including the acquired position as a generation range, and display the preview image in an enlarged manner.

### BRIEF DESCRIPTION OF THE DRAWINGS

Exemplary embodiment(s) of the present invention will be described in detail based on the following figures, wherein:

FIG. 1 is a block configuration diagram of a multifunction machine that forms an image processing system according to Exemplary Embodiment 1;

FIG. 2 is a schematic perspective view of the multifunction machine according to Exemplary Embodiment 1;

FIG. 3 is a hardware configuration diagram of a multifunction machine according to Exemplary Embodiment 1;

FIG. 4 is a flowchart showing reading attribute setting processing according to Exemplary Embodiment 1;

FIG. 5A is a diagram showing a display example of a check screen according to Exemplary Embodiment 1;

FIG. 5B is a diagram showing a display example in a case where a preview image is superimposed and displayed on the check screen shown in FIG. 5A;

FIG. 5C is a diagram showing a display example in a case where a setting change button is selected on the check screen shown in FIG. 5B;

FIG. 5D is a diagram showing a display example in a case where a resolution is selected as a reading attribute of a change target on the check screen shown in FIG. 5C;

FIG. 5E is a diagram showing a display example in a case where the preview image regenerated in accordance with an attribute value selected on the check screen shown in FIG. 5D is superimposed and displayed;

FIG. 6 is a block configuration diagram of a multifunction machine that forms an image processing system according to Exemplary Embodiment 2;

FIG. 7 is a diagram showing a data configuration example of attribute value setting information stored in an attribute value setting information storage unit according to Exemplary Embodiment 2;

FIG. 8 is a flowchart showing reading attribute setting processing according to Exemplary Embodiment 2; and

FIG. 9 is a diagram showing a display example in a case where a setting change button is selected on the check screen shown in FIG. 5B in Exemplary Embodiment 2.

### DETAILED DESCRIPTION

Hereinafter, exemplary embodiments of the present invention will be described with reference to the drawings.

### Exemplary Embodiment 1

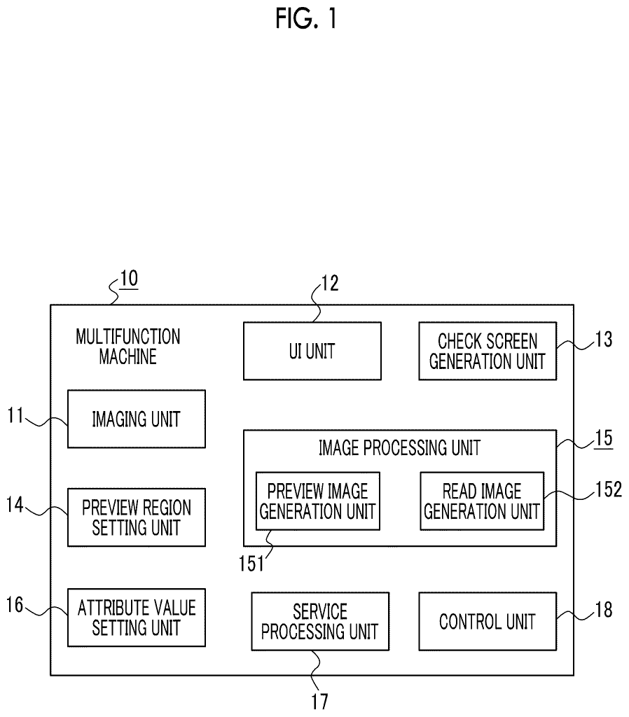

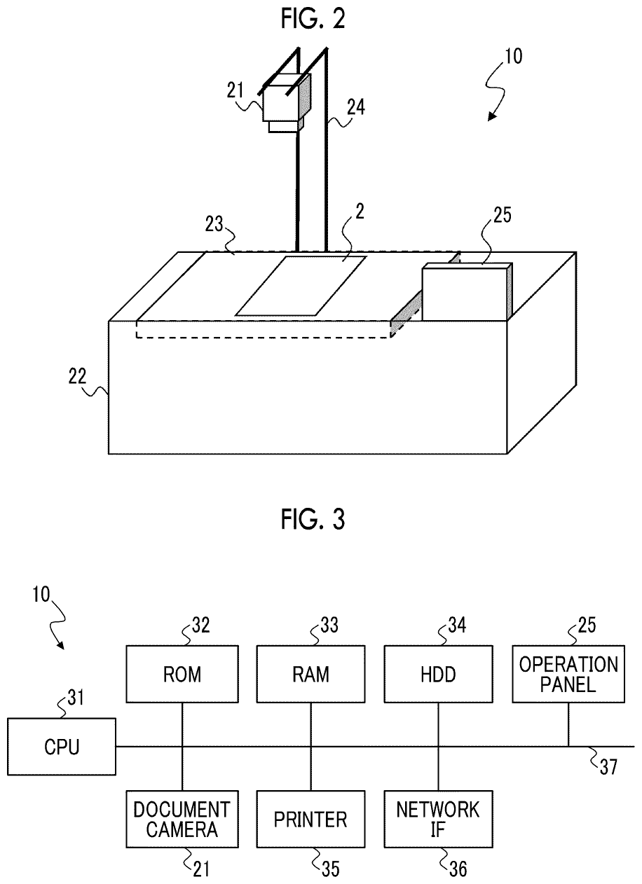

FIG. 1 is a block configuration diagram of a multifunction machine 10 that forms an image processing system according to an exemplary embodiment of the present invention. FIG. 2 is a schematic perspective view of the multifunction machine 10 in the present exemplary embodiment, and FIG. 3 is a hardware configuration diagram of the multifunction machine 10 in the present exemplary embodiment.

The multifunction machine 10 in the present exemplary embodiment is characterized in that, as the apparatus configuration, a document camera 21 is mounted as shown in FIG. 2.

The multifunction machine 10 is provided with an original document table 23 on an upper surface of an apparatus body 22, and the document camera 21 that sets a range in which the entire original document table 23 can be imaged. The document camera 21 is supported by a support rod 24. Further, an operation panel 25 that functions as an input unit operated by a user and as a display unit that displays information is provided on the upper surface of the apparatus body 22.

The multifunction machine 10 in the present exemplary embodiment is an image forming apparatus having various functions such as a printing function, a copying function, and a scanning function, and is an apparatus in which a computer is built in. That is, as shown in FIG. 3, the multifunction machine 10 includes a CPU 31, a ROM 32, a RAM 33, a hard disk drive (HDD) 34 as a storage unit, the operation panel 25 as a user interface, the document camera 21 as an imaging unit, a printer 35 that provides a printing function, and a network interface (IF) 36 as a communication unit. An address data bus 37 connects the various mechanisms 31 to 36, 21, and 25 that are control targets by the CPU 31 and performs data communication.

Incidentally, in a multifunction machine that has been known in the related art generally, a scanner that optically reads an original document 2 on the original document table 23 in order to realize a scanning function is mounted. In the multifunction machine 10 in the present exemplary embodiment, the document camera 21 is mounted instead of the scanner. Therefore, a read image of the original document 2 is generated by a captured image obtained by imaging with the document camera 21 or by performing image processing on the captured image.

Although the document camera 21 generates the captured image of the original document 2 by capturing the original document 2 on the original document table 23, it can be said that the original document 2 is read by capturing the original document 2, and thus the terms “capture” and “read” are used synonymously without strict distinction in the present exemplary embodiment. Therefore, “captured” by the document camera 21 may be referred to as “read” or “scanned” by replacing the “captured” by the document camera 21 with “read”.

As shown in FIG. 1, the multifunction machine 10 in the present exemplary embodiment includes an imaging unit 11, a user interface (UI) unit 12, a check screen generation unit 13, a preview region setting unit 14, an image processing unit 15, an attribute value setting unit 16, a service processing unit 17, and a control unit 18. The components that are not used in the description in the present exemplary embodiment are omitted from the drawings.

The imaging unit 11 is realized by the document camera 21 and images the entire upper surface of the original document table 23 as an imaging range. The user interface unit 12 is realized by the operation panel 25 and displays a screen or the like of various menus in the multifunction machine 10. The user interface unit 12 receives a user operation on the displayed screen. The check screen generation unit 13 generates a check screen to be shown below. The preview region setting unit 14 sets a predetermined range including a position designated by the user in the captured image of the original document captured by the document camera 21 as a preview region. The preview region is a generation range of the preview image in the present exemplary embodiment.

The image processing unit 15 executes image processing on the captured image by the document camera 21 as a processing target. The image processing unit 15 includes a preview image generation unit 151 and a read image generation unit 152. The preview image generation unit 151 generates the preview image based on a reading attribute designated by the user. The “reading attribute” is an attribute item related to reading of the original document 2 among the attribute items added to the original document 2. Examples of the attribute item corresponding to the reading attribute include a resolution or sharpness related to an image quality, a file format in a case of saving a read image, a color mode, a frame erasure, and a reading size. Incidentally, examples of the attribute item that does not correspond to the reading attribute include the creation date and time and the creator. As the reading attribute, an item of a general attribute that has been used in the related art may be used.

The read image generation unit 152 generates the read image of the original document in accordance with the attribute value of the reading attribute designated by the user from the captured image obtained by the document camera 21. Since the document camera 21 captures the entire upper surface of the original document table 23 as the imaging range, the captured image of the original document 2 is obtained by extracting the imaging range of the original document 2 from the captured image by the document camera 21. The read image generation unit 152 generates the read image of the original document 2 by performing image processing required for the captured image of the original document 2, as will be described later.

The attribute value setting unit 16 sets the attribute value selected by the user by operating the check screen, as the attribute value of the reading attribute. The service processing unit 17 realizes a service designated by the user by using the read image of the original document generated by the read image generation unit 152. A service provided to the user by the multifunction machine 10 includes a transmission service for transmitting the read image of the original document to a designated address. The control unit 18 controls the operations of each of the components 11 to 17.

Each of the components 11 to 18 in the multifunction machine 10 is realized by a cooperative operation of the computer mounted on the multifunction machine 10 and a program operated by the CPU 31 mounted on the computer.

Further, the program used in the present exemplary embodiment may be not only provided by a communication unit but also provided by storing the program in a computer readable recording medium such as a USB memory. The program provided from the communication unit or the recording medium is installed in the computer, and various types of processing are realized by sequentially executing the program by the CPU 31 of the computer.

In addition, the multifunction machine 10 constituting the image processing system is shown as a single apparatus, but may be realized by combining a plurality of computers or apparatuses. For example, the multifunction machine 10 may perform the image processing, and the user interface may use another information processing apparatus such as a PC.

Hereinafter, an operation of the present exemplary embodiment will be described.

In a case where the user uses an intended service in which the original document is scanned by the multifunction machine 10, the user logs in to the multifunction machine 10 and performs an operation of selecting the intended service from a home screen or the like displayed on the operation panel 25. The document camera 21 starts imaging at a constant time interval in response to the user operation. The imaging by the document camera 21 is referred to as “pre-scanning” because the imaging is started after the selection of the service and before the user gives an instruction to scan the original document 2. On the other hand, the scanning performed to obtain the read image of the original document 2 in response to the execution instruction for the service or the scanning instruction from the user is referred to as “major scanning”.

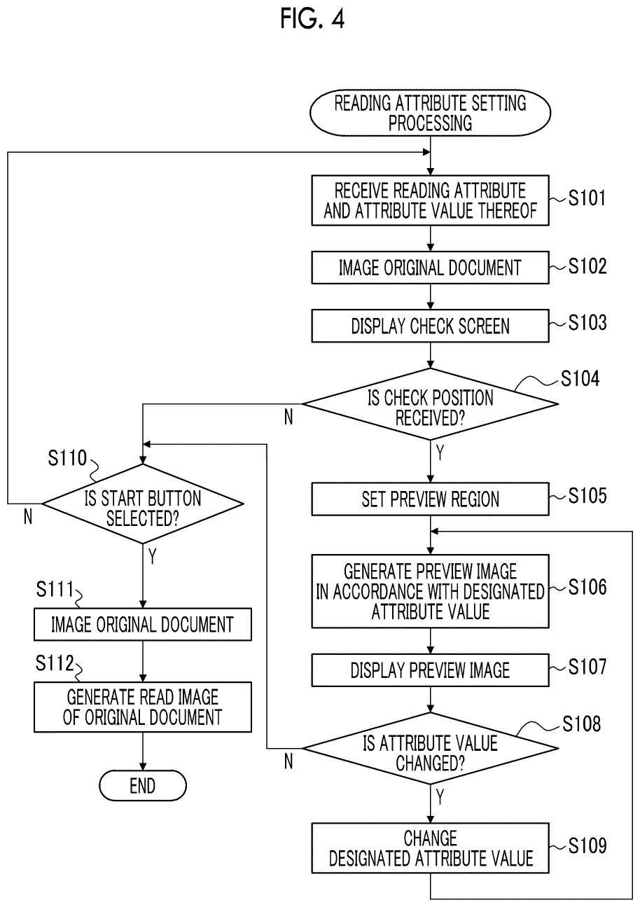

The user places the original document 2 on the original document table 23 before or after the selection of the service. In this case, the user places the original document 2 such that a printing surface to be read by the document camera 21 faces upward. Here, it is assumed that the user uses one original document 2 to use the service. Hereinafter, the reading attribute setting processing of the original document 2 in the present exemplary embodiment will be described with reference to the flowchart shown in FIG. 4.

As described above, in a case where the user selects the service that requires scanning of the original document from the home screen or the like displayed on the operation panel 25, the imaging unit 11 starts the imaging of the original document 2 on the original document table 23 by using the document camera 21 at the constant time interval in response to this user operation. Here, it is assumed that the user selects, for example, a transmission service for transmitting the read image of the original document to a designated destination. In this case, the user sets the reading attribute to be checked in the preview image before the read image of the original document 2 is generated, the attribute value thereof, and a transmission destination of the read image of the original document 2 from the screen (not shown) corresponding to the service. Here, it is assumed that the user inputs and designates, for example, “resolution” as the reading attribute and “200 dpi” as the attribute value of the resolution.

In a case where the user interface unit 12 receives the reading attribute and the attribute value designated by the user (step S101), the imaging unit 11 images the original document 2 (step S102).

As described above, the document camera 21, that is, the imaging unit 11 that starts the imaging performs the imaging at the constant time interval, but since it is necessary to image the original document 2 on the original document table 23 to obtain the captured image of the original document 2, the processing of imaging the original document 2 is clearly indicated in the flowchart.

The check screen generation unit 13 displays the captured image of the original document 2 and generates the check screen for allowing the user to perform a check. The user interface unit 12 displays the generated check screen on the operation panel 25 (step S103).

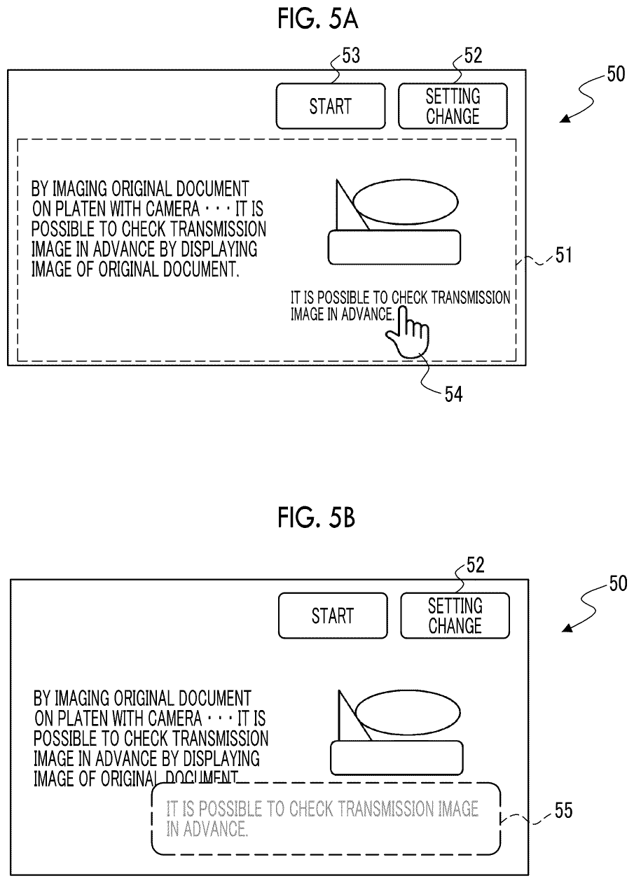

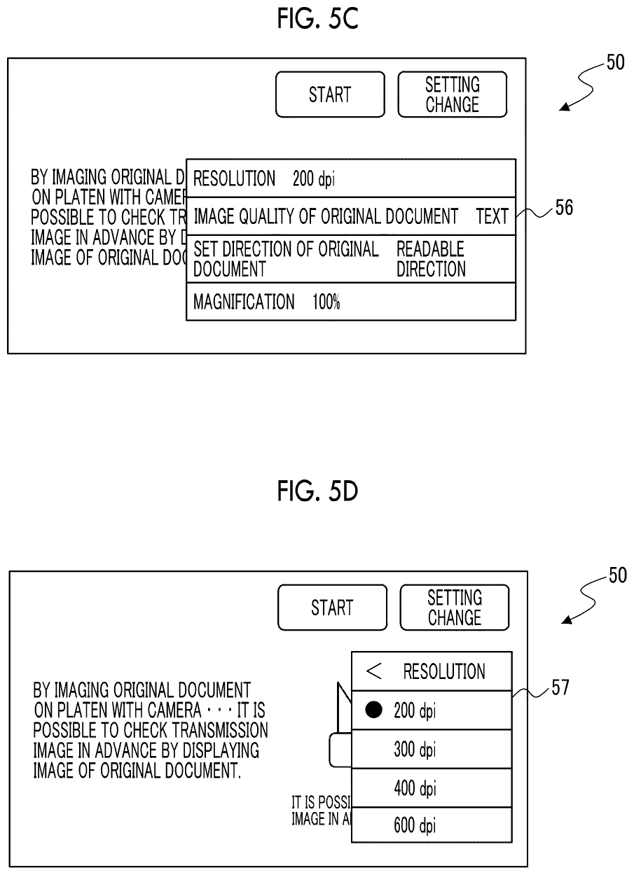

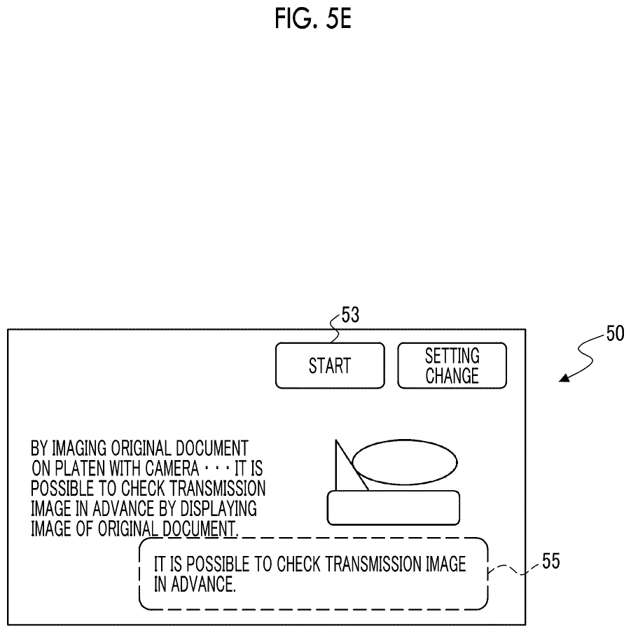

FIG. 5A is a diagram showing a display example of a check screen 50 in the present exemplary embodiment. The check screen 50 shows a display region 51 of the captured image of the original document 2, a setting change button 52, and a start button 53. The check screen generation unit 13 extracts an image of the original document 2 from the captured image obtained by the document camera 21, and displays the image in the display region 51. An image captured by the document camera 21 in accordance with, for example, an initial setting is displayed in the display region 51 without depending on the reading attribute of the read image of the original document 2.

Here, the user refers to the captured image of the original document 2 displayed on the check screen 50. A next instruction that can be given by the user includes an operation for checking the appropriateness/inappropriateness of the attribute value of the resolution, which is the reading attribute designated in a case where the service is selected, and an operation for executing the major scanning. Here, in the former case, that is, in a case where the user wants to check the appropriateness/inappropriateness of the attribute value of the resolution designated by the user, a portion of the captured image of the original document 2 in which the resolution is particularly to be checked is tapped. That is, a portion of the original document 2 displayed on the operation panel 25 in which the resolution is to be checked is selected. Basically, it is considered that, in a portion having a relatively small text size of the text, the difference is likely to appear depending on the attribute value, and thus it is estimated that the user searches for the portion having the small text on the read image of the original document 2 and taps the portion. FIG. 5A shows a portion (hereinafter, a “check position”) 54 to be checked by the user in the image of the finger.

Incidentally, the original document 2 is often formed by combining contents such as a document and a figure. In addition, even in the document, a plurality of contents can be divided and handled in a polite language and for each paragraph. These contents can be handled as objects in the related art. Therefore, as described above, in a case where the user designates the check position 54 on the captured image of the original document 2, the user interface unit 12 receives and acquires the check position 54. In this case (Y in step S104), the preview region setting unit 14 sets a partial region including the check position 54, that is, a display region of the image of one object as the preview region (step S105). As described above, the check position 54 designated by the user is expanded to a range of an object image.

Subsequently, the preview image generation unit 151 in the image processing unit 15 extracts an image corresponding to the preview region from the captured image of the original document 2, and generates the preview image in accordance with the attribute value of the reading attribute designated by the user by performing image processing on the extracted image (step S106). In the present exemplary embodiment, only the partial region including the check position 54 designated as the position at which the resolution is to be checked by the user is set as the generation range of the preview image instead of the preview image of the entire original document 2, and thus the efficiency is high. The user interface unit 12 enlarges the preview image generated in this way, and displays the enlarged preview image in a superimposed manner on the check screen 50 (step S107).

FIG. 5B is a diagram showing a display example of the check screen 50 in a case where the preview image is displayed in a superimposed manner. In a preview image display region 55 shown in FIG. 5B, the preview image generated at the resolution of 200 dpi designated by the user is displayed in an enlarged manner. A display position or a shape of the preview image display region 55 and an enlargement/reduction ratio of the content are not particularly limited as long as the user can check the preview image. The size or the display position of the preview image display region 55 may be changeable in response to the user operation. In FIG. 5B, the text is shown to be displayed in a thin manner for convenience to represent a state where the text is difficult to be identified at the resolution of 200 dpi.

In a case where the user determines that the preview image is not sufficiently readable at the resolution of 200 dpi, the user selects the setting change button 52. In a case where the setting change button 52 is selected, the attribute value setting unit 16 displays a reading attribute selection screen 56 in a superimposed manner on the check screen 50. FIG. 5C shows a display example of the check screen 50 in a case where the reading attribute selection screen 56 is displayed in a superimposed manner.

On the reading attribute selection screen 56 shown in FIG. 5C, the reading attribute and the attribute value of the reading attribute at the current point in time are displayed in a list as a set. The user selects the resolution from the list. Here, the resolution is selected by the user as the reading attribute of the processing target, and thus the resolution is displayed at the top on the reading attribute selection screen 56 as shown in FIG. 5C. Here, in a case where the user selects the resolution from the reading attribute selection screen 56, the attribute value setting unit 16 performs display on the check screen 50 corresponding to the reading attribute “resolution” in a superimposed manner instead of the reading attribute selection screen 56. FIG. 5D shows a display example of the check screen 50 in a case where an attribute value selection screen 57 is displayed in a superimposed manner.

With reference to the attribute value selection screen 57 shown in FIG. 5D, it can be seen that the multifunction machine 10 can obtain four attribute values of 200 dpi, 300 dpi, 400 dpi, and 600 dpi as the resolution. Since “e” is currently attached, it can be seen that 200 dpi is currently selected as the attribute value of the resolution. Here, in a case where the user wants to increase the resolution to, for example, 400 dpi, the user selects “400 dpi” from among the selection candidates displayed on the attribute value selection screen 57.

In a case where the user provides an operation instruction to change the attribute value of the resolution from the current 200 dpi to 400 dpi (Y in step S108), the user interface unit 12 receives the designated attribute value “400 dpi”. The attribute value setting unit 16 changes the set attribute value of the resolution in accordance with the received attribute value (step S109).

Subsequently, the preview image generation unit 151 extracts an image corresponding to the preview image display region 55 from the captured image of the original document 2, and regenerates the preview image in accordance with the attribute value of the reading attribute changed by the user by performing image processing on the extracted image (step S106). The user interface unit 12 displays the regenerated preview image in a superimposed manner on the check screen 50 in this way (step S107).

FIG. 5E is a diagram showing a display example of the check screen 50 in a case where the regenerated preview image is displayed in a superimposed manner. In the preview image display region 55 shown in FIG. 5E, the preview image of the preview region generated at the resolution of 400 dpi designated by the user is displayed in an enlarged manner. In the preview image display region 55 shown in FIG. 5E, in a case where the resolution is 400 dpi, the text is in a state of being easily identifiable than 200 dpi, and the text is displayed darker than the preview image display region 55 shown in FIG. 5B to indicate that the text is readable.

The shape of the preview image display region 55 after the attribute value is changed does not need to be changed from the shape before the attribute value is changed, but may be changed in order to make the preview image easy to check depending on the reading attribute.

In the present exemplary embodiment, as shown in FIGS. 5B and 5E, a display example in which the preview image based on the attribute value before the setting change is updated by the preview image based on the attribute value after the setting change is shown. However, both the preview images before and after the change may be displayed side by side such that the difference between the attribute values before and after the change is easily compared.

In the present exemplary embodiment, the steps S106 to S109 can be repeatedly processed, and thus the user can check various attribute values.

As described above, the appropriateness/inappropriateness of the attribute value for the reading attribute is checked in the preview image. Then, in a case where it is checked that a sufficiently readable resolution is selected, the user selects the start button 53. In this case (N in step S108 and Y in step S110), the imaging unit 11 images the original document 2 (step S111). As described above, the imaging performed in response to the explicit operation instruction by the user, which is the selection of the start button 53, corresponds to the “major scanning” described above. The read image generation unit 152 cuts out and extracts a range in which the original document 2 is imaged from the captured image. The read image generation unit 152 performs image processing on the captured image of the original document 2 such that the read image corresponding to the set attribute value is obtained. For example, in a case where the resolution is set to 400 dpi, the image processing is performed such that the resolution is 400 dpi. In a case where the document camera 21 performs the imaging at the resolution of 400 dpi, it is not necessary to convert the resolution. In this way, the read image generation unit 152 generates the read image of the original document 2 by the major scanning (step S112).

As described above, in a case where the read image of the original document 2 is generated, the service processing unit 17 performs the service selected by the user, here, a service of transmitting the read image of the original document 2 to the designated transmission destination.

In the present exemplary embodiment, two operation instructions by the user, that is, the setting change of the attribute value by the selection of the setting change button 52 and the execution of the major scanning by the selection of the start button 53 are received. However, the user may want to check the attribute value for the reading attribute other than the reading attribute designated in step S101 and to change the attribute value as necessary by the above-described processing. Therefore, the check screen 50 shown in FIG. 5A is provided with a button (not shown) for moving the processing to step S101, and in a case where this button is operated (N in step S110), the attribute value may be checked for the reading attribute other than the attribute designated first in step S101, and the setting of the attribute value may be changeable.

Incidentally, among the reading attributes, there are reading attributes in addition to the reading attribute in which the obtainable attribute value (200 dpi, 300 dpi, 400 dpi, and 600 dpi described above), such as “resolution”, is determined in advance and the attribute values can be set by being selected by the user from among the selection candidates. For example, there is also the reading attribute in which the user designates an intended numerical value, for example, between 0% and 100%. In this case, the attribute value setting unit 16 needs to display an attribute value setting screen for designating the numerical value instead of the attribute value selection screen 57 shown in FIG. 5D. Alternatively, one or more attribute values may be selected from a range obtainable as the attribute value and selected as candidates for the attribute value obtainable for the typical reading attribute, and the attribute value selection screen 57 may be generated and displayed to display the selection candidates as described above.

In the present exemplary embodiment, in a case where the setting change button 52 is selected in a state in which the check screen 50 shown in FIG. 5B is displayed, the reading attributes are displayed in a list (FIG. 5C). However, since the reading attribute that is the processing target is designated by the user in step S101, the processing may be performed such that the screen transitions from FIG. 5B to FIG. 5D instead of FIG. 5C.

### Exemplary Embodiment 2

In Exemplary Embodiment 1, in a case where the user is allowed to check the attribute value set for a certain reading attribute (for example, resolution) in the preview image, the user is allowed to designate the partial region including the position to be checked, that is, the preview region. However, the position selected by the user as the preview region can be estimated to some extent by the reading attribute. That is, it is estimated that the user designates a position on the original document 2 on which the difference is likely to appear depending on the attribute value obtainable for the reading attribute. For example, in a case where the reading attribute is a reading attribute related to the image quality such as the resolution, it is considered that the user designates a position of a text having a relatively small text size, specifically, a position of text having a minimum text size. In a case where the reading attribute is “frame erasure”, the position is a position at which a frame is present in the read image of the original document 2, and in a case where the reading attribute is “background color removal”, the position is a position at which the object image such as a text or a figure, which is easy to check the background color, is not present.

Therefore, in the present exemplary embodiment, the check position 54, that is, the preview region is automatically set without being designated by the user.

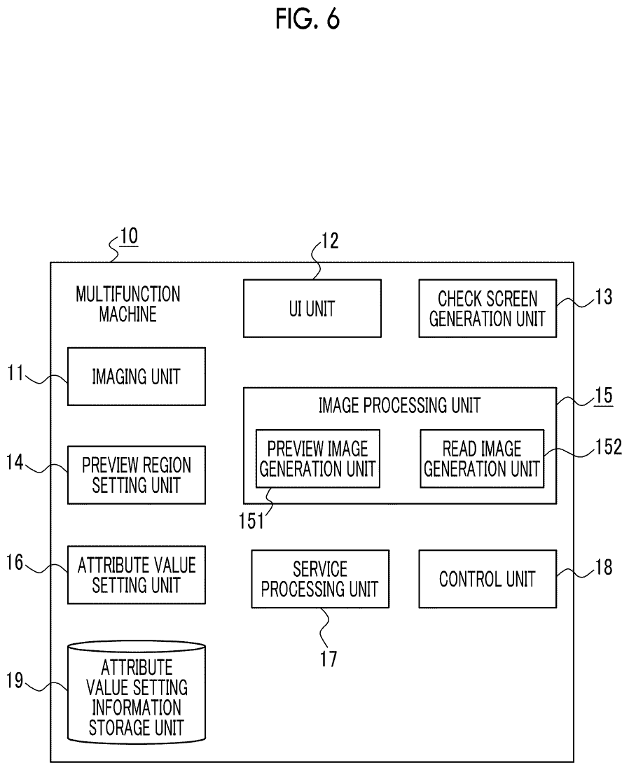

FIG. 6 is a block configuration diagram of the multifunction machine that forms the image processing system in the present exemplary embodiment. The identical reference numerals are given to the identical components as in FIG. 1 in Exemplary Embodiment 1, and the description thereof will be appropriately omitted. The multifunction machine 10 in the present exemplary embodiment has a configuration in which the multifunction machine 10 shown in Exemplary Embodiment 1 is added with an attribute value setting information storage unit 19. The attribute value setting information storage unit 19 is set in advance with attribute value setting information.

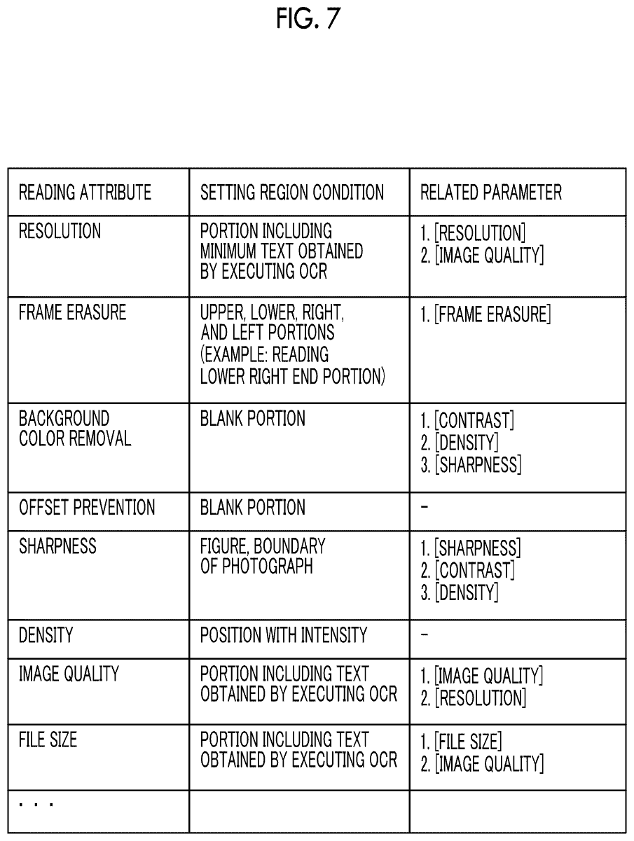

FIG. 7 is a diagram showing a data configuration example of the attribute value setting information stored in the attribute value setting information storage unit 19 according to Exemplary Embodiment 2.

The attribute value setting information is set in association with a setting region condition and a related parameter in the reading attribute. The setting region condition is a condition for setting the partial region on the original document 2, that is, the preview region in which the difference is likely to appear depending on the attribute value obtainable for the reading attribute. In the setting region condition in a case where the reading attribute shown in FIG. 7 is the resolution, a setting condition of the preview region is set in which the sizes of the texts extracted by performing OCR, that is, text recognition processing on the read image of the original document 2 are compared, and the partial region including the text having the minimum text size is set as the preview region. In the present exemplary embodiment, the smallest text among the texts included in the original document 2 is handled as the text having a relatively small text size. In Exemplary Embodiment 1, in a case where the user wants to change the attribute value of the reading attribute designated in step S101, the reading attributes are displayed in a list as shown in FIG. 5C, and the reading attributes displayed in a list are set in the related parameters together with the display order.

The attribute value setting information storage unit 19 is realized by the hard disk drive (HDD) 34 mounted on the multifunction machine 10. Alternatively, the RAM 33 or an external storage unit may be used via a network.

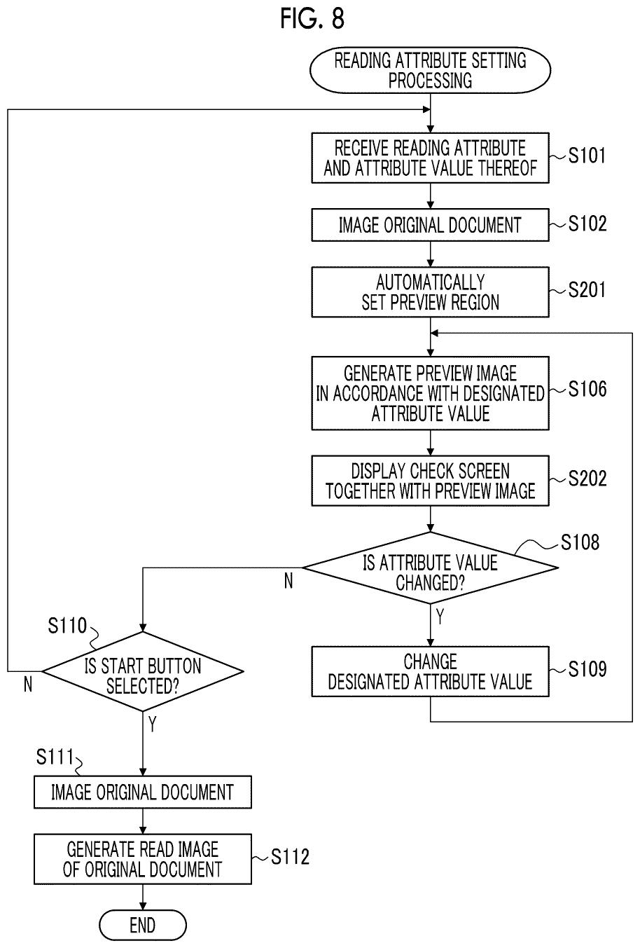

Hereinafter, the reading attribute setting processing of the original document 2 in the present exemplary embodiment will be described with reference to the flowchart shown in FIG. 8. The identical processing step to in Exemplary Embodiment 1 is denoted by the identical step number, and the description thereof will be appropriately omitted.

Similar to Exemplary Embodiment 1, the user selects a service that requires scanning of the original document from the home screen or the like displayed on the operation panel 25, and further sets the reading attribute to be checked in the preview image before the read image of the original document 2 is generated, the attribute value thereof, and the transmission destination of the read image of the original document 2. In the present exemplary embodiment, the description is made that the user inputs and designates “resolution” as the reading attribute and “200 dpi” as the attribute value of the resolution.

As described above, in the present exemplary embodiment, the preview region is automatically set without allowing the user to designate the position on the original document 2. Therefore, in a case where the reading attribute and the attribute value thereof are input and designated by the user, the preview region setting unit 14 automatically sets the preview region with reference to the attribute value setting information (step S201). Specifically, the operation is performed as follows.

That is, the preview region setting unit 14 first performs the OCR, which is a function of the multifunction machine 10, on the read image of the original document 2 in accordance with to the setting region condition set to correspond to the reading attribute designated by the user, here, the resolution, and sets a partial region including a text having a minimum size among the extracted texts, more specifically, a region corresponding to an object including the text having the minimum size, as the preview region.

Subsequently, the preview image generation unit 151 generates the preview image in accordance with the attribute value of the reading attribute designated by the user, in the same manner as in Exemplary Embodiment 1 (step S106). As a result of the above-described processing, the user interface unit 12 displays the preview image in a superimposed manner on the check screen 50, as in the check screen 50 as shown in FIG. 5B (step S202). Since the subsequent processing may be the identical to in Exemplary Embodiment 1, the description thereof will be omitted.

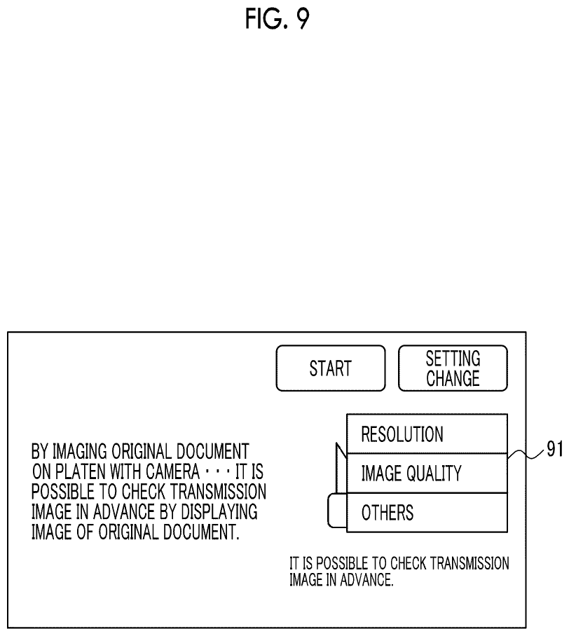

However, in a case where the setting change button 52 is selected by the user on the check screen 50 shown in FIG. 5B, the attribute value setting unit 16 in the present exemplary embodiment acquires the reading attribute that is a setting change target of the attribute value with reference to the related parameter set in the attribute value setting information, and displays the reading attributes in a list on the attribute value selection screen 91, unlike the check screen 50 (FIG. 5C) in Exemplary Embodiment 1. A display example of the check screen 50 in this case is shown in FIG. 9.

As shown in FIG. 9, the reading attribute set in the related parameter in the attribute value setting information is displayed on the attribute value selection screen 91 in the set display order. In the attribute value selection screen 91 shown in FIG. 9, “others” is included such that the reading attribute not set in the related parameter can be used as the change target. That is, the user selects “others” to display the reading attributes other than the resolution and the image quality in a list, and thus the user may select the reading attribute for which the appropriateness/inappropriateness of the attribute value is to be checked from the list.

For example, in a case where the related parameter is not set as in the case where the reading attribute in the attribute value setting information shown in FIG. 7 is “density”, in a case where the setting change button 52 is selected on the check screen 50 shown in FIG. 5B, the screen may be directly transitioned to a screen for setting the attribute value without displaying the attribute value selection screen.

In the above description, the resolution is described as an example of the reading attribute. For example, in a case where the user designates “frame erasure” of the original document 2 as “present” as the reading attribute instead of the resolution, the preview region setting unit 14 executes a frame erasure function of the multifunction machine 10 in accordance with the setting region condition in which the reading attribute of the attribute value setting information is “frame erasure”, to set a preview region including the upper, lower, right, and left portions of the original document 2, here, the lower right end portion of the read image of the original document 2.

In a case where the user designates “background color removal” as “present” as the reading attribute, the preview region setting unit 14 executes a background color removal function of the multifunction machine 10 in accordance with the setting region condition in which the reading attribute in the attribute value setting information is “background color removal”, to set a preview region including a blank portion in which the text, the figure, or the object of the original document 2 is not displayed.

According to the present exemplary embodiment, the preview region can be automatically set without allowing the user to designate the check position 54, and the user can be allowed to check the preview image.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An image processing system comprising:
an imaging unit; and
a processor,
wherein the processor is configured to:
   display a captured image of an original document captured by the imaging unit in a case where a reading attribute set by a user in a case where a read image of the original document is generated, and an attribute value of the reading attribute are designated;
   acquire a position on the captured image designated by the user;
   generate a preview image of the original document in accordance with the designated attribute value by using a partial region on the original document including the acquired position as a generation range; and
   display the preview image in an enlarged manner.
      (((2)))

The image processing system according to (((1))), wherein the processor is configured to:
set a partial region on the original document in which a difference is likely to appear depending on an attribute value obtainable for the reading attribute designated by the user, as the generation range of the preview image without designating the position by the user.
   (((3)))

The image processing system according to (((1))) or (((2))), wherein the processor is configured to:
execute text recognition processing on the captured image of the original document in a case where the user designates a reading attribute related to an image quality; and
set a partial region on the original document including a position of a text having a relatively small text size among texts on the original document obtained by the text recognition processing, as the generation range of the preview image.
   (((4)))

The image processing system according to any one of (((1))) to (((3))), wherein the processor is configured to:
display selection candidates for the attribute value of the reading attribute in response to a setting change instruction from the user;
regenerate the preview image of the original document from the captured image of the original document by using the partial region as the generation range in accordance with the attribute value selected by the user from among the selection candidates; and display the regenerated preview image in an enlarged manner.
   (((5)))

The image processing system according to any one of (((1))) to (((4))),
wherein the partial region is a display region of one object on the original document.
   (((6)))

A program causing a computer to realize:
a function of displaying a captured image of an original document captured by an imaging unit in a case where a reading attribute set by a user in a case where a read image of the original document is generated, and an attribute value of the reading attribute are designated;
a function of acquiring a position on the captured image designated by the user;
a function of generating a preview image of the original document by using a partial region on the original document including the acquired position as a generation range; and
a function of displaying the preview image in an enlarged manner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing system comprising:
an imaging unit; and
a processor,
wherein the processor is configured to:
display a captured image of an original document captured by the imaging unit in a case where a reading attribute set by a user in a case where a read image of the original document is generated, and an attribute value of the reading attribute are designated;
acquire a position on the captured image designated by the user;
generate a preview image of the original document in accordance with the designated attribute value by using a partial region on the original document including the acquired position as a generation range; and
display the preview image in an enlarged manner.

2. The image processing system according to claim 1, wherein the processor is configured to:
set a partial region on the original document in which a difference is likely to appear depending on an attribute value obtainable for the reading attribute designated by the user, as the generation range of the preview image without designating the position by the user.

3. The image processing system according to claim 2, wherein the processor is configured to:
execute text recognition processing on the captured image of the original document in a case where the user designates a reading attribute related to an image quality; and
set a partial region on the original document including a position of a text having a relatively small text size among texts on the original document obtained by the text recognition processing, as the generation range of the preview image.

4. The image processing system according to claim 1, wherein the processor is configured to:
display selection candidates for the attribute value of the reading attribute in response to a setting change instruction from the user;
regenerate the preview image of the original document from the captured image of the original document by using the partial region as the generation range in accordance with the attribute value selected by the user from among the selection candidates; and
display the regenerated preview image in an enlarged manner.

5. The image processing system according to claim 1,
wherein the partial region is a display region of one object on the original document.

6. A non-transitory computer readable medium storing a program causing a computer to realize:
a function of displaying a captured image of an original document captured by an imaging unit in a case where a reading attribute set by a user in a case where a read image of the original document is generated, and an attribute value of the reading attribute are designated;
a function of acquiring a position on the captured image designated by the user;
a function of generating a preview image of the original document by using a partial region on the original document including the acquired position as a generation range; and
a function of displaying the preview image in an enlarged manner.

7. An image processing method comprising:
displaying a captured image of an original document captured by an imaging unit in a case where a reading attribute set by a user in a case where a read image of the original document is generated, and an attribute value of the reading attribute are designated;
acquiring a position on the captured image designated by the user;
generating a preview image of the original document by using a partial region on the original document including the acquired position as a generation range; and
displaying the preview image in an enlarged manner.
